(19) United States
(12) Patent Application Publication
(10) Pub. No.: US 2007/0218362 A1
(43) Pub. Date: Sep. 20, 2007

(54) Lithium Ion Secondary Battery

(76) Inventors: Akira Nagasaki, Osaka (JP); Hajime Nishino, Nara (JP)

Correspondence Address: MCDERMOTT WILL & EMERY LLP, 600 13TH STREET, NW, WASHINGTON, DC, 20005-3096, US

(21) Appl. No.: 11/587,261

(22) PCT Filed: Apr. 22, 2005
(86) PCT No.: PCT/JP05/07730

§ 371 Date: Oct. 23, 2006

(30) Foreign Application Priority Data
Apr. 23, 2004 (JP) 2004-127853

(51) Int. Cl. H01M 4/52; H01M 4/62

(52) U.S. Cl. 429/231.3; 429/231.6; 429/231.5; 429/217

(57) ABSTRACT

There is provided a lithium ion secondary battery that includes a positive electrode having high thermal stability and is capable of greatly reducing the possibility of causing thermal runaway even in a nail penetration test. A lithium ion secondary battery including a positive electrode including a lithium composite oxide and a porous film bonded to at least one of a surface of the positive electrode and a surface of a negative electrode, wherein the porous film includes an inorganic oxide filler and a film binder, and the lithium composite oxide is represented by the formula: Liₐ(Co_{1-x-y}Mₓ¹M_{y}²)_{b}O₂ (wherein element M¹ is at least one selected from the group consisting of Mg, Sr, Y, Zr, Ca and Ti, element M² is at least one selected from the group consisting of Al, Ga, In and Tl, and 0<a≦1.05, 0.005≦x≦0.15, 0≦y≦0.05 and 0.85≦b≦1.1).

### TECHNICAL FIELD

The present invention relates to a lithium ion secondary battery including a positive electrode with high thermal stability and offering improved safety against short circuit, and particularly relates to a lithium ion secondary battery that has greatly reduced the possibility that the battery temperature exceeds 80° C. when short circuit is caused by a nail penetration test or the like. The present invention is to solve problems that are unique to use of a positive electrode having high thermal stability.

### BACKGROUND ART

In recent years, high capacity and lightweight non-aqueous secondary batteries, particularly lithium ion secondary batteries are being widely used as power sources for portable electronic devices. A lithium ion secondary battery includes a porous resin separator that serves to electrically insulate a positive electrode and a negative electrode, and further to retain a non-aqueous electrolyte. As the resin separator, resins that tend to undergo thermal deformation, such as a polyolefin resin, are used. The positive electrode includes a positive electrode current collector comprising a conductive material such as Al and a positive electrode material mixture layer carried thereon, and the negative electrode includes a negative electrode current collector comprising a conductive material such as Cu and a negative electrode material mixture layer carried thereon.

Since the resin separator tends to undergo thermal deformation at a relatively low temperature, it may undergo thermal deformation such as contraction upon increase of the battery temperature when the battery is brought into a overcharged state or when minute short circuit occurs, so that it may have a width that is smaller than that of the positive electrode or the negative electrode. In that case, there is the possibility that the positive electrode and the negative electrode having increased reactivity come in contact with each other, thus accelerating heating.

On the other hand, it has been proposed to form a porous film comprising inorganic fine particles and a resin binder on the electrode for improving the safety of the lithium ion secondary battery (for example, see Patent Document 1). Such a porous film does not contract even if the battery temperature is increased, which reduces the possibility that the positive electrode and the negative electrode having increased reactivity come in contact with each other.

However, since the structure of the electrode plate is destroyed in a complicated way during a nail penetration test or the like, the positive electrode current collector having high conductivity and the negative electrode current collector or negative electrode material mixture layer also having high conductivity may come into contact with each other, thus causing internal short circuit that causes a large current to flow. In such a case, with the technique of Patent Document 1, it is difficult to ensure a high level of safety (for example, the safety where the maximum battery temperature reached can be suppressed at 80° C. or lower).

In addition, in heating tests that anticipate abnormal modes, such as a heating test at 150° C. that is specified in UL Standards, the positive electrode active material is exposed to a thermally unstable temperature region. Accordingly, the positive electrode active material having a crystal structure with low thermal stability causes a chain reaction involving heat generation, which also induces, for example, contraction of the separator and thus accelerates heat generation in the battery.

Patent Document 1 Laid-Open Patent Publication No. Hei 7-220759

### DISCLOSURE OF THE INVENTION

### Problem To be Solved by the Invention

As discussed above, even if a porous film is formed on the electrode, it is not easy to ensure a high level of safety in a nail penetration test and a heating test at a high temperature. Furthermore, although it is preferable to use a positive electrode active material having excellent thermal stability from the viewpoint of ensuring the safety in a heating test, using a positive electrode active material having excellent thermal stability is disadvantageous on the contrary from the viewpoint of ensuring the safety in a nail penetration test. According to the findings of the present inventors, when a different kind of element is added to the positive electrode active material for improving the thermal stability, the powder resistivity of the active material decreases. It has been found that this causes a reduction in the resistance of a short circuit portion in a nail penetration test, thus causing an excessive current to flow and decreasing the safety. That is, using a positive electrode having high thermal stability makes it difficult to ensure the safety in a nail penetration test conversely.

In view of the foregoing, it is an object of the present invention to provide an extremely safe lithium ion secondary battery that includes a positive electrode having high thermal stability and can greatly reduce the possibility that the battery temperature exceeds 80° C. even if short circuit is caused by a nail penetration test or the like.

### MEANS FOR SOLVING THE PROBLEM

Even if a porous film is bonded to the surface of the electrode, it is very difficult to ensure a high level of safety (for example, the safety where the maximum battery temperature reached can be suppressed at 80° C. or lower) in a nail penetration test. Therefore, it can be expected that using a positive electrode active material that reduces the safety in a nail penetration test, i.e., a positive electrode active material having excellent thermal stability makes it very difficult to ensure the safety in a nail penetration test. However, if the positive electrode active material having excellent thermal stability has a specific composition, then the safety in a nail penetration test tends to improve when a porous film is bonded to a surface of an electrode, contrary to the case where no porous film is bonded thereto. The present invention is based on such findings, and proposes to use a highly thermally stable positive electrode active material having a specific composition, and to bond a porous film to a surface of an electrode.

That is to say, the present invention relates to a lithium ion secondary battery including: a positive electrode including a lithium composite oxide; a negative electrode including a material capable of electrochemically absorbing and desorbing lithium; a separator interposed between the positive electrode and the negative electrode; a non-aqueous electrolyte; and a porous film bonded to at least one selected from a surface of the positive electrode, a surface of the negative electrode and a surface of the separator, wherein the porous film includes an inorganic oxide filler and a film binder, and the lithium composite oxide is represented by the formula: Liₐ(Co_{1-x-y}Mₓ¹M_{y}²)_{b}O₂, where element M¹ is at least one selected from the group consisting of Mg, Sr, Y, Zr, Ca and Ti, and element M² is at least one selected from the group consisting of Al, Ga, In and Tl, and the formula satisfies 0<a≦1.05, 0.005≦x≦0.15, 0≦y≦0.05 and 0.85≦b≦1.1.

The positive electrode generally includes a positive electrode current collector and a positive electrode material mixture layer carried on both sides thereof. The negative electrode generally includes a negative electrode current collector and a negative electrode material mixture layer carried on both sides thereof. Usually, the shape of the positive electrode and the negative electrode is a band shape, but not particularly limited thereto. The lithium composite oxide is a positive electrode active material, and the material capable of electrochemically absorbing and desorbing lithium is a negative electrode active material.

Although a metal foil is usually used for the positive and negative electrode current collectors, it is possible to use materials that are conventionally known to a skilled person as current collectors for the electrode plates for non-aqueous secondary batteries, without any particular limitations. The metal foil may be subjected to various surface treatments, or may be mechanically processed. Usually, the current collector has a band-shaped form before it is wound, or in completed batteries. It is preferable to use Al or an Al alloy for the positive electrode current collector. It is preferable to use Cu or a Cu alloy for the negative electrode current collector.

The positive and negative electrode material mixture layers are each obtained by forming, into a layer, a material mixture including an active material as the essential components, a binder, a conductive material, a thickener and the like as optional components. In general, the material mixture layer is formed by applying, onto the current collector, a paste in which the material mixture is dispersed in a liquid component, including for example water, N-methyl-2-pyrrolidone (hereinafter, “NMP”) or cyclohexanone, drying it, and rolling the dried coating.

The separator is usually obtained by forming a resin or a resin composition into a form of a sheet, and further drawing it. While there is no particular limitation with respect to such a resin serving as the source material of the separator, it is possible to use, for example, polyolefin resins such as polyethylene and polypropylene, polyamide, polyethylene terephthalate (PET), polyamide imide and polyimide.

While the non-aqueous electrolyte comprises a non-aqueous solvent in which a solute is dissolved, it is possible to use a lithium salt as the solute, and various organic substances as the non-aqueous solvent.

The porous film is electronically insulating, and serves the function common to a conventional separator, but is different from the separator firstly in that it is carried or bonded onto the electrode material mixture layer. The porous film has very high resistance to thermal contraction and thermal deformation. Furthermore, the porous film is different from the separator, which is obtained by drawing a resin sheet, secondly in that it has a structure in which the particles of an inorganic oxide filler are bonded to one another with a film binder. Accordingly, although the porous film has a lower tensile strength in the planar direction than that of the separator, the porous film is superior in that it does not undergo thermal contraction even when it is exposed to a high temperature, unlike the separator. The porous film prevents expansion of a short circuit portion when short circuit occurs or when the battery is exposed to a high temperature, thus preventing an abnormal increase of the battery temperature.

The present invention encompasses all cases where the porous film is disposed such that it is interposed between the positive electrode and the negative electrode. More specifically, the present invention encompasses all of the case where the porous film is bonded to a surface of the positive electrode only, the case where it is bonded to a surface of the negative electrode only, the case where it is bonded to a surface of the separator only, the case where it is bonded to both a surface of the positive electrode and a surface of the negative electrode, the case where it is bonded to a surface of the positive electrode and a surface of the separator, the case where it is bonded to a surface of the negative electrode and a surface of the separator, the case where it is bonded to a surface of the positive electrode, a surface of the negative electrode and a surface of the separator. Furthermore, the present invention encompasses the case where the porous film is bonded to only one side of the positive electrode, the case where it is bonded to both sides of the positive electrode, the case where it is bonded to only one side of the negative electrode, the case where it is bonded to both sides of the negative electrode, the case where it is bonded to only one side of the separator, and the case where it is bonded to both sides of the separator.

The inorganic oxide filler is a particulate or powdery inorganic oxide, and is the main component of the porous film.

It is preferable that the inorganic oxide filler includes at least one selected from the group consisting of alumina and magnesia.

It is preferable that the content of the inorganic oxide filler in the total of the inorganic oxide filler and the film binder is not less than 50 wt % and not more than 99 wt %.

The film binder comprises a resin component, and has the effects of bonding the particles of the inorganic oxide filler together, and further bonding the porous film to the surface of the electrode.

It is preferable that the film binder has a decomposition starting temperature of not less than 250° C.

It is preferable that the film binder has a softening point of 150 to 200° C., for example. Additionally, although the softening point may be measured by any method, it is preferable to use, for example, the following method. First, the film binder is formed into a form of a sheet. The tip of a vertically disposed needle-shaped terminal is brought into contact with the obtained sheet, and the sheet is heated, while applying thereto a fixed load vertically. The temperature at which the tip of the terminal greatly sinks into the sheet at this time can be defined as the softening point.

It is preferable that the film binder includes a rubbery polymer including an acrylonitrile unit.

The form of the lithium ion secondary battery according to the present invention is not particularly limited, and includes various types such as a cylindrical shape, a square shape and a laminated shape; however, the present invention is particularly effective for cylindrical or square batteries that include an electrode plate group in which the positive electrode and the negative electrode are wound with the separator disposed between them. That is, it is preferable that the positive electrode and the negative electrode are wound with the separator interposed therebetween.

### EFFECT OF THE INVENTION

With the present invention, since the positive electrode active material has a thermally stable crystal structure, it is possible to ensure a high level of safety of the battery in a heating test at a high temperature, and ensure a high level of safety of the battery also in a nail penetration test. In the following, the mechanism for realizing the effects is described, along with observations.

In the case of using, as the positive electrode active material, a lithium composite oxide represented by the formula: Liₐ(Co_{1-x-y}Mₓ¹M_{y}²)_{b}O₂, wherein element M¹ is at least one selected from the group consisting of Mg, Sr, Y, Zr, Ca and Ti, element M² is at least one selected from the group consisting of Al, Ga, In and Tl, and 0≦a≦1.05, 0.005≦x≦0.15, 0≦y≦0.05 and 0.85≦b≦1.1 are satisfied, the safety in a nail penetration test shows the opposite tendency depending on the presence or absence of the porous film.

More specifically, when a lithium composite oxide containing the element M¹ within the range of 0.005≦x≦0.15 is used as the positive electrode active material, it is usually difficult to ensure the safety in a nail penetration test. Although not clearly known, the reason seems to be that the element M¹ increases the thermal stability of the crystal structure of the lithium composite oxide, thus increasing the conductivity of the lithium composite oxide and promoting an excessive current to flow during nail penetration.

On the other hand, when a lithium composite oxide containing the element M¹ within the range of 0.005≦x≦0.15 is used as the positive electrode active material, the safety in a nail penetration test improves significantly, contrary to the expectation, if the porous film is bonded to a surface of an electrode. Although not clearly known, the reason seems to be related to the adhesion of the positive electrode active material in the positive electrode material mixture layer.

When the exposure of the positive electrode current collector is reduced by an increase in the adhesion of the positive electrode active material, the increase in the battery temperature in a nail penetration test is suppressed. This is related to the fact that short circuit occurs mainly due to the contact between the positive electrode current collector having high conductivity and the negative electrode current collector or the negative electrode material mixture layer also having high conductivity. That is, the improvement of the safety in a nail penetration test is greatly influenced by the adhesion of the positive electrode active material.

It seems that, in a nail penetration test, a part of the film binder is dissolved out, and enters into the positive electrode material mixture layer when the temperature of the battery increases to a high temperature. It seems that the film binder that has entered into the positive electrode material mixture layer increases the adhesion of the positive electrode active material, thus preventing the positive electrode material mixture layer from being peeled off from the positive electrode current collector. In order to suppress the temperature increase in the battery by such an effect, it is necessary to improve the adhesion of the positive electrode active material rapidly. It seems that, when the positive electrode active material has excellent conductivity, the battery temperature rapidly increases to a certain temperature to cause the dissolution of the film binder, so that the adhesion of the positive electrode active material is improved rapidly.

### BRIEF DESCRIPTION OF THE DRAWINGS

FIG. 1 is a vertical cross-sectional view showing an example of a cylindrical lithium ion secondary battery.

FIG. 2 is a graph showing a relationship between the addition amount (x) of element M¹ included in a lithium composite oxide and the maximum temperature reached during nail penetration.

FIG. 3 is a graph showing a relationship between the addition amount (x) of element M¹ included in a lithium composite oxide and the battery capacity.

FIG. 4 is a graph showing a relationship between the addition amount (y) of element M² included in a lithium composite oxide and the maximum temperature reached during nail penetration.

FIG. 5 is a graph showing a relationship between the addition amount (y) of element M² included in a lithium composite oxide and the battery capacity.

### BEST MODE FOR CARRYING OUT THE INVENTION

The present invention relates to a lithium ion secondary battery including: a positive electrode including a lithium composite oxide; a negative electrode including a material capable of electrochemically absorbing and desorbing lithium; a separator interposed between the positive electrode and the negative electrode; a non-aqueous electrolyte; and a porous film bonded to at least one selected from a surface of the positive electrode and a surface of the negative electrode.

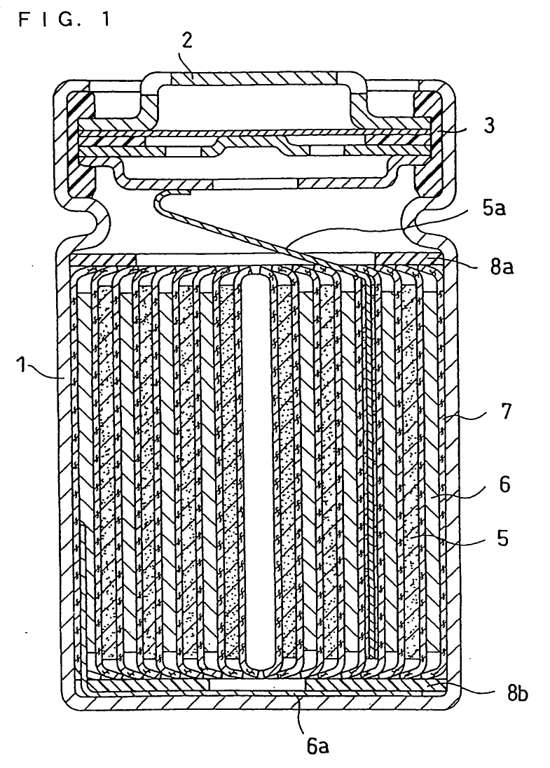

FIG. 1 is a vertical cross-sectional view showing an example of a common cylindrical lithium ion secondary battery. A positive electrode 5 and a negative electrode 6 are wound with a separator 7 disposed between them, and form a columnar electrode plate group. One end of a positive electrode lead 5a is connected to the positive electrode 5, and one end of a negative electrode lead 6a is connected to the negative electrode 6. The electrode plate group impregnated with a non-aqueous electrolyte is housed in the space in a battery can 1 such that it is sandwiched between an upper insulating ring 8a and a lower insulating ring 8b. The separator is disposed between the electrode plate group and the inner surface of the battery can 1. The other end of the positive electrode lead 5a is welded to the back surface of a battery cover 2, and the other end of the negative electrode lead 6a is welded to the inner bottom surface of the battery can 1. The opening of the battery can 1 is covered with the battery cover 2 having an insulating packing 3 disposed at its periphery. It should be noted that FIG. 1 is merely one embodiment of the lithium ion secondary battery of the present invention, and the applicable range of the present invention is not limited to the case shown in FIG. 1.

Although not shown in FIG. 1, a porous film is bonded to at least one of a surface of the positive electrode, a surface of the negative electrode and a surface of the separator. When the positive electrode and the negative electrode are wound with the separator interposed therebetween, heat tends to be accumulated within the battery due to the structure of the electrode plate group, and it is particularly important to ensure the safety. Therefore, the present invention is particularly effective when the positive electrode and the negative electrode are wound with the separator interposed therebetween.

The lithium composite oxide included in the positive electrode as the active material is represented by the formula: Liₐ(Co_{1-x-y}Mₓ¹M_{y}²)_{b}O₂. The crystal structure of this composite oxide is the same as or similar to that of LiCoO₂, and considered to be a structure in which Co is partly replaced with the element M¹, or with the element M¹ and the element M² in the crystal structure of LiCoO₂.

In the formula, the element M¹ is at least one selected from the group consisting of Mg, Sr, Y, Zr, Ca and Ti, element M² is at least one selected from the group consisting of Al, Ga, In and Tl, and the formula satisfies 0≦a≦1.05, 0.005≦x≦0.15, 0≦y≦0.05 and 0.85≦b≦1.1. Although only the lithium composite oxide represented by the formula: Liₐ(Co_{1-x-y}Mₓ¹M_{y}²)_{b}O₂ may be used as the positive electrode active material, it is possible to use another material together that can be used as the positive electrode active material of a lithium ion secondary battery. However, it is preferable that the lithium composite oxide represented by the formula: Liₐ(Co_{1-x-y}Mₓ¹M_{y}²)_{b}O₂ occupies not less than 50 wt % of the whole positive electrode active material.

As the element M¹, one selected from the group consisting of Mg, Sr, Y, Zr, Ca and Ti may be used singly, or two or more of these may be used in combination. Among them, Mg is particularly preferable in that it has a great effect of increasing the thermal stability of the crystal structure of the lithium composite oxide. In addition, the element M¹ has the effect of increasing the conductivity of the lithium composite oxide. Usually, when the conductivity of the lithium composite oxide increases, the temperature increase in a nail penetration test becomes violent and it is very difficult to prevent the battery temperature from increasing to 80° C. or higher. On the other hand, when the conductivity of the lithium composite oxide increases, the increase in the battery temperature in a nail penetration test is effectively suppressed in the present invention, conversely. Although not clearly known, the reason seems to be that the film binder in the porous film is softened instantaneously or a portion thereof is dissolved owing to a temperature increase of the lithium composite oxide having high conductivity, thus increasing the adhesion of the positive electrode material mixture layer and suppressing the exposure of the positive electrode current collector.

As the element M², one selected from the group consisting of Al, Ga, In and Tl may be used singly, or two or more of these may be used in combination. Among them, Al is particularly preferable. It seems that a lithium composite oxide including the element M² improves the adhesion between the film binder and itself at a high temperature, thus increasing the effect of suppressing the exposure of the positive electrode current collector. Furthermore, it seems that Al also has the effect of improving the heat resistance and the cycle characteristics of the composite oxide.

The formula: Liₐ(Co_{1-x-y}Mₓ¹M_{y}²)_{b}O₂ satisfies 0<a≦1.05, 0.005≦x≦0.15, 0≦y≦0.05 and 0.85≦b≦1.1.

The value of “a” changes within the range of 0<a≦1.05 with charge/discharge of the lithium ion secondary battery. However, immediately after producing the lithium composite oxide (that is, in a fully discharged state), it is preferable that 0.95≦a≦1.05. The battery capacity decreases when the value of “a” is less than 0.95, and the rate characteristics decreases when the value of “a” exceeds 1.05.

The value of “b” is usually 1, but may fluctuate within the range of 0.85≦b≦1.1, depending on the manufacturing conditions for the lithium composite oxide or other factors. Therefore, it is rare that the value of “b” is less than 0.85, or exceeds 1.1.

The value of “x” corresponds to the content of the element M¹ in the lithium composite oxide, and it is necessary to satisfy 0.005≦x≦0.15, and it is preferable to satisfy 0.01≦x≦0.10. When the value of “x” is less than 0.005, it is not possible to increase the thermal stability of the crystal structure of the lithium composite oxide, making it impossible to ensure the safety in a heating test performed under stringent conditions and also making it difficult to ensure the safety in a nail penetration test regardless of the presence or absence of the porous film. On the other hand, when the value of “x” exceeds 0.15, the battery capacity decreases significantly.

The value of “y” corresponds to the content of the element M² in the lithium composite oxide, and it is necessary to satisfy 0≦y≦0.05, and it is preferable to satisfy 0.01≦y≦0.03. Although the element M² is an optional component, it seems that a small amount of the element M² increases the adhesion between the lithium composite oxide and the film binder at a high temperature, making it difficult for the positive electrode material mixture layer to be separated from the positive electrode current collector. However, when the value of “y” exceeds 0.05, the battery capacity decreases significantly.

While the lithium composite oxide may be produced by any method, it can be obtained, for example, by mixing a lithium salt, a cobalt salt, a salt of the element M¹ and a salt of the element M², and baking the mixture at a high temperature under an oxidizing atmosphere. While there is no particular limitation with respect to the material for synthesizing the lithium composite oxide, it is possible to use the following, for example.

As the lithium salt, it is possible to use lithium carbonate, lithium hydroxide, lithium nitrate, lithium sulfate, lithium oxide and the like. As the cobalt salt, it is possible to use cobalt oxide, cobalt hydroxide and the like. As the salt of the element M¹, for example, a magnesium salt, it is possible to use magnesium oxide, basic magnesium carbonate, magnesium chloride, magnesium fluoride, magnesium nitrate, magnesium sulfate, magnesium acetate, magnesium oxalate, magnesium sulfide, magnesium hydroxide and the like. As the salt of the element M², for example, an aluminum salt, it is possible to use aluminum hydroxide, aluminum oxide, aluminum nitrate, aluminum fluoride, aluminum sulfate and the like.

Further, the lithium composite oxide can also be obtained by preparing cobalt hydroxide containing the element M¹ or the element M² by a co-precipitation method, then mixing this with a lithium salt or the like, followed by baking.

Although there is no particular limitation with respect to the positive electrode active material that can be included in the positive electrode according to the present invention in addition to the lithium composite oxide represented by the formula: Liₐ(Co_{1-x-y}Mₓ¹M_{y}²)_{b}O₂, it is preferable to use lithium cobaltate (LiCoO₂), a modified product of lithium cobaltate, lithium nickelate (LiNiO₂), a modified product of lithium nickelate, lithium manganate (LiMn₂O₄), a modified product of lithium manganate, materials obtained by partly replacing Co, Ni or Mn in these oxides with another transition metal element or a typical metal, a compound widely called as olivinic acid that contains iron as the main constituent element, or the like. These may be used singly, or two or more of them may be used in combination.

The positive electrode includes, for example, a positive electrode binder and a conductive material as optional components.

While there is no particular limitation with respect to the positive electrode binder, it is possible to use, for example, polytetrafluoroethylene (PTFE), a modified product of PTFE, polyvinylidene fluoride (PVDF), a modified product of PVDF, and modified acrylonitrile rubber particles, polyacrylonitrile derivative rubber particles (for example, “BM-500B (trade name)” manufactured by ZEON Corporation). These may be used singly, or two or more of them may be used in combination. PTFE or BM-500B is preferably used together with a thickener. As the thickener, carboxymethyl cellulose (CMC), polyethylene oxide (PEO), a modified acrylonitrile rubber (for example, “BM-720H (trade name)” manufactured by ZEON Corporation) and the like are suitable. As the conductive agent, it is possible to use acetylene black, ketjen black, various graphites and the like. These may be used singly, or two or more of them may be used in combination.

The negative electrode includes a material capable of absorbing and desorbing lithium ion as the negative electrode active material. While there is no particular limitation with respect to the negative electrode active material, it is possible to use various natural graphites, various artificial graphites, petroleum coke, carbon fibers, a carbon material such as a baked product of an organic polymer, an oxide, silicon, tin, a silicon-containing composite material such as silicides, a tin-containing composite material, various metals or alloy materials, and the like. These may be used singly, or two or more of them may be used in combination.

The negative electrode includes, for example, a negative electrode binder and a thickener as optional components.

Although there is no particular limitation with respect to the negative electrode binder, rubber particles are preferable from the viewpoint of the capability of exhibiting binding property in a small amount, and those including a styrene unit and a butadiene unit are particularly preferable. For example, it is possible to use a styrene-butadiene copolymer (SBR) and a modified product of SBR including an acrylic acid unit or an acrylate unit. These may be used singly, or two or more of them may be used in combination. In the case of using rubber particles as the negative electrode binder, it is preferable to use a thickener comprising a water-soluble polymer together. As the water-soluble polymer, a cellulose-based resin is preferable, and CMC is particularly preferable. Each of the amounts of the rubber particles and the thickener included in the negative electrode is preferably 0.1 to 5 parts by weight per 100 parts by weight of the negative electrode active material. As the negative electrode binder, it is also possible to use PVDF, a modified product of PVDF and the like.

The porous film includes an inorganic oxide filler and a film binder, and has a microporous structure. The microporous structure is formed by gaps in the inorganic oxide filler. The content of the inorganic oxide filler in the total of the inorganic oxide filler and the film binder is preferably not less than 50 wt % and not more than 99 wt %, more preferably not less than 80 wt % and not more than 99 wt %, and particularly preferably not less than 90 wt % and not more than 97 wt %. When the content of the inorganic oxide filler is too small, the content of the film binder is large, so that it is difficult to control the microporous structure and the ion migration is impeded by the film binder, thus possibly decreasing the charge/discharge characteristics of the battery. When the content of the inorganic oxide filler is too large, on the other hand, the content of the film binder is small, so that the strength of the porous film or its adhesion to the surface of the electrode decreases, possibly causing separation of the porous film.

From the viewpoint of obtaining a porous film having high heat resistance, it is preferable that the inorganic oxide filler has a heat resistance of 250° C. or higher and is electrochemically stable in the potential window of the non-aqueous electrolyte secondary battery. While many inorganic oxide fillers satisfy these conditions, alumina, magnesia, silica, zirconia, titania and the like are preferable among inorganic oxides, and alumina and magnesia are particularly preferable. One of the inorganic oxide fillers may be used singly, or two or more of them may be used as a mixture.

From the viewpoint of obtaining a porous film having favorable ionic conductivity, it is preferable that the inorganic oxide filler has a bulk density (tap density) of not less than 0.2 g/cm³ and not more than 0.8 g/cm³. When the bulk density is less than 0.2 g/cm³, the inorganic oxide filler is too bulky, so that the structure of the porous film may be brittle. When the bulk density exceeds 0.8 g/cm³, on the other hand, it may be difficult to form suitable gaps between the filler particles. While there is no particular limitation with respect to the particle diameter of the inorganic oxide filler, the bulk density tends to be low when the particle diameter is small.

Although there is no particular limitation with respect to the shape of the inorganic oxide filler particles, particles of indefinite shape in which plural (for example, about 2 to about 10, preferably 3 to 5) primary particles are connected and fixed are preferable. Since a primary particle usually comprises a single crystal, particles of indefinite shape are inevitably polycrystalline particles. It is preferable that the particles of indefinite shape includes polycrystalline particles having a dendritic shape, a coralloid shape, a clustered shape or the like. Such polycrystalline particles tend not to form an excessively densely filled structure in the porous film, and is therefore suitable for forming moderate gaps. Examples of the polycrystalline particles include particles in which about 2 to about 10 primary particles are connected by being melted, and particles in which about 2 to about 10 particles have come into contact in the process of the crystal growth and thus been united.

The average particle diameter of the primary particles constituting the polycrystalline particles is preferably not more than 3 μm, and more preferably not more than 1 μm. When the average particle diameter of the primary particles exceeds 3 μm, the amount of the film binder becomes excessive as a result of a decrease in the surface area of the filler, so that the porous film may tend to be swelled with the non-aqueous electrolyte. It should be noted that when the primary particles cannot be clearly identified in the polycrystalline particles, the particle diameter of the primary particles is defined based on the thickest part of the knot of the polycrystalline particles.

The average particle diameter of the primary particles can be determined, for example, by measuring the particle diameter of at least 10 primary particles using a SEM image or a TEM image of the polycrystalline particles, and obtaining their average. Further, in the case of obtaining the polycrystalline particles by diffusion bonding the primary particles by a heat treatment, the average particle diameter (median diameter on a volume basis: D50) of the primary particles as the source material can be treated as the average particle diameter of the primary particles constituting the polycrystalline particles. Such a heat treatment that promotes diffusion bonding hardly causes a fluctuation of the average particle diameter of the primary particles.

The average particle diameter of the polycrystalline particles is not less than twice the average particle diameter of the primary particles, and preferably not more than 10 μm, more preferably not more than 3 μm. It should be noted that the average particle diameter (median diameter on a volume basis: D50) of the polycrystalline particles can be measured, for example, using a wet type laser particle size distribution measurement apparatus manufactured by Microtrac Inc., or the like. When the average particle diameter of the polycrystalline particles is less than twice the average particle diameter of the primary particles, the porous film may have an excessively densely packed structure, and when it exceeds 10 μm, the porosity of the porous film becomes excessive, thus possibly making the structure of the porous film brittle.

While there is no particular limitation with respect to the method of obtaining the polycrystalline particles, they can be obtained, for example, by sintering an inorganic oxide to form a massive material, and appropriately pulverizing the massive material. Alternatively, it is also possible to directly obtain the polycrystalline particles by causing the particles during the crystal growth to come in contact with each other, without performing the pulverization step. For example, in the case of obtaining the polycrystalline particles by sintering α-alumina into a massive material and appropriately pulverizing the massive material, the sintering temperature is preferably 800 to 1300° C., and the sintering time is preferably 3 to 30 minutes. Further, in the case of pulverizing the massive material, the pulverization can be performed using wet type equipment such as a ball mill, or dry type equipment such as a jet mill or a jaw crusher. In that case, a skilled person would be able to control the polycrystalline particles to have an arbitrary average particle diameter by appropriately adjusting the pulverizing conditions.

The film binder is required to be heat resistant to some degree and have the effect of increasing the adhesion of the active material particles in the positive electrode material mixture layer at a high temperature. From the viewpoint of heat resistance, the thermal decomposition temperature of the film binder is preferably not less than 250° C. In a nail penetration test, the heat generation temperature may locally exceed several hundred degrees Celsius, depending on the conditions. At such a high temperature, a film binder having a decomposition starting temperature of less than 250° C. is excessively softened or burnt out, thus possibly deforming the porous film and making it difficult to ensure the safety.

The melting point or decomposition starting temperature of the film binder can be determined by performing a differential scanning calorimetry (DSC) or a thermogravimetry-differential thermal analysis (TG-DTA) on a sample of the film binder and obtaining the temperature of the point of inflection in the DSC measurement or the temperature of the starting point of weight change in the TG-DTA measurement.

As the film binder, it is possible to use, for example, styrene butadiene rubber (SBR), a modified product of SBR including an acrylic acid unit or an acrylate unit, polyethylene, polytetrafluoroethylene (PTFE), polyvinylidene fluoride (PVDF), a tetrafluoroethylene-hexafluoropropylene copolymer (FEP), a copolymer including an acrylonitrile unit (in particular, a rubbery polymer including an acrylonitrile unit), a polyacrylic acid derivative, a polyacrylonitrile derivative and carboxymethyl cellulose (CMC). These may be used singly, or two or more of them may be used in combination. Among them, a copolymer including an acrylonitrile unit (for example, modified acrylic rubber such as BM-720H (trade name) manufactured by ZEON Corporation), a polyacrylic acid derivative (for example, polyacrylic acid-based derivative rubber particles such as BM-500B (trade name) manufactured by ZEON Corporation), a polyacrylonitrile derivative and the like are particularly preferable.

The copolymer including an acrylonitrile unit preferably includes a —(CH₂)ₙ— structure (4≦n), in addition to the acrylonitrile unit. The polyacrylic acid derivative preferably includes at least one selected from the group consisting of an acrylonitrile unit, a methyl acrylate unit, an ethyl acrylate unit, a methyl methacrylate unit and an ethyl methacrylate unit. The polyacrylonitrile derivative preferably includes at least one selected from the group consisting of an acrylic acid unit, a methyl acrylate unit, an ethyl acrylate unit, a methyl methacrylate unit and an ethyl methacrylate unit.

Additionally, a film binder having rubber elasticity is advantageous in that a high production yield of the batteries can be maintained since it improves the impact resistance of the porous film, thus making it difficult to cause cracking or the like especially when winding the positive electrode and the negative electrode with the separator interposed therebetween. From such a viewpoint, a rubbery polymer including an acrylonitrile unit is particularly preferable.

The thickness of the porous film is preferably, but not particularly limited to, 0.5 to 20 μm, from the viewpoint of fully achieving the effect of the porous film to improve the safety and maintaining the design capacity of the battery. Although the porous film may include plural layers having different compositions, the total thickness thereof is preferably 0.5 to 20 μm. Further, the total thickness of the separator and the porous film is preferably 10 to 30 μm.

For example, the porous film bonded to a surface of the electrode can be obtained by preparing a paint including an inorganic oxide filler and a film binder (hereinafter, a “porous film paint”), applying this onto the surface of the electrode, and drying the coating. The porous film paint can be obtained by mixing the inorganic oxide filler and the film binder with a dispersion medium of the filler. Although it is preferable to use an organic solvent such as N-methyl-2-pyrrolidone (NMP) and cyclohexanone, or water as a dispersion medium, the dispersion medium is not limited to these. The mixing of the inorganic oxide filler, the film binder and the dispersion medium can be performed using a double arm kneader such as a planetary mixer or a wet type dispersing machine such as a beads mill. Examples of the methods of applying the porous film paint onto the surface of the electrode include a comma roll method, a gravure roll method and a die coating method.

The concentration of the lithium salt dissolved in the non-aqueous solvent in the non-aqueous electrolyte is generally 0.5 to 2 mol/L. As the lithium salt, it is preferable to use lithium hexafluorophosphate (LiPF₆), lithium perchlorate (LiClO₄), lithium tetrafluoroborate (LiBF₄) or the like. These may be used singly, or two or more of them may be used in combination.

While there is no particular limitation with respect to the non-aqueous solvent, it is possible to use, for example: carbonic acid esters such as ethylene carbonate (EC), propylene carbonate (PC), dimethyl carbonate (DMC), diethyl carbonate (DEC) and ethylmethyl carbonate (EMC); carboxylic acid esters such as γ-butyrolactone, γ-valerolactone, methyl formate, methyl acetate and methyl propionate; and ethers such as dimethyl ether, diethyl ether and tetrahydrofuran. One of the non-aqueous solvents may be used singly, or two or more of them may be used in combination. Among them, it is particularly preferable to use the carbonic acid esters. In order to form a good film on the electrode and ensure the safety and the like at the time of overcharge, vinylene carbonate (VC), cyclohexylbenzene (CHB), a modified product of VC or CHB, or the like may be added to the non-aqueous electrolyte.

Although there is no particular limitation with respect to the material of the separator, the separator is preferably based on a resin material having a melting point of not more than 200° C., and it is particularly preferable to use polyolefin. In particular, polyethylene, polypropylene, a ethylene-propylene copolymer, a composite material of polyethylene and polypropylene and the like are preferable. A separator made of polyolefin having a melting point of not more than 200° C. easily melts when the battery is short-circuited by an external factor, and can exert a so-called “shutdown effect”. The separator may be a single layer film comprising one kind of a polyolefin resin, or may be a multiple layer film comprising two or more kinds of polyolefin resins. The thickness of the separator is preferably, but not particularly limited to, 8 to 30 μm, from the viewpoint of maintaining the design capacity of the battery.

### EXAMPLES

Next, the present invention is described specifically by way of examples, but the following examples are not intended to limit the present invention.

### Example 1

(i) Production of Positive Electrode

An aqueous solution containing cobalt sulfate (CoSO₄) at a concentration of 0.95 mol/L and magnesium nitrate at a concentration of 0.05 mol/L was continuously supplied into a reaction vessel, while adding sodium hydroxide dropwise into the reaction vessel such that the pH of water was 10 to 13, thereby synthesizing a hydroxide, namely Co_{0.95}Mg_{0.05}(OH)₂, serving as the precursor of the active material. This precursor was placed in a baking furnace, and preliminary baked at 500° C. for 12 hours in the air atmosphere, thereby obtaining a predetermined oxide.

The oxide obtained by the preliminary baking and lithium carbonate were mixed such that the molar ratio of lithium, cobalt and magnesium was 1:0.95:0.05, and the mixture was temporarily baked at 600° C. for 10 hours, followed by pulverization.

Subsequently, the pulverized baked product was baked again at 900° C. for 10 hours (final baking), followed by pulverization and classification, thereby obtaining a lithium composite oxide (positive electrode active material) represented by the chemical formula Li(Cu_{0.95}Mg_{0.05})O₂.

A positive electrode material mixture paste was prepared by stirring, with an double arm kneader, 3 kg of the obtained lithium composite oxide, 1 kg of “#1320 (trade name)” manufactured by KUREHA CORPORATION as a binder, 90 g of acetylene black and a proper amount of N-methyl-2-pyrrolidone (NMP). It should be noted that #1320 manufactured by KUREHA CORPORATION is an NMP solution containing 12 wt % of polyvinylidene fluoride (PVDF).

The positive electrode material mixture paste was applied onto both sides of a 15 μm-thick aluminum foil (positive electrode current collector), which was dried and then rolled to form positive electrode material mixture layers. At this time, the total thickness of the electrode plate comprising the aluminum foil and the positive electrode material mixture layers was 160 μm. Thereafter, the electrode plate was cut to have a width that could be inserted into a battery case (diameter: 18 mm, height: 65 mm) for a cylindrical battery, thereby obtaining a positive electrode hoop.

(ii) Production of Negative Electrode

A negative electrode material mixture paste was prepared by stirring, with an double arm kneader, 3 kg of artificial graphite (negative electrode active material), 75 g of “BM-400B (trade name)” manufactured by ZEON Corporation as a binder, 30 g of carboxymethyl cellulose (CMC) as a thickener and a proper amount of water. It should be noted that BM-400B manufactured by ZEON Corporation is an aqueous dispersion containing 40 wt % of a styrene-butadiene copolymer.

The negative electrode material mixture paste was applied onto both sides of a 10 μm-thick copper foil (negative electrode current collector), which was dried and then rolled to form negative electrode material mixture layers. At this time, the total thickness of the electrode plate comprising the copper foil and the negative electrode material mixture layers was 180 μm. Thereafter, the electrode plate was cut to have a width that could be inserted into the above-described battery case, thereby obtaining a negative electrode hoop.

(ii) Preparation of Non-Aqueous Electrolyte

A non-aqueous electrolyte was prepared by dissolving lithium hexafluorophosphate (LiPF₆) at a concentration of 1 mol/L in a mixed solvent containing ethylene carbonate (EC), dimethyl carbonate (DMC) and methyl ethyl carbonate (MEC) at a volume ratio of 2:3:3, and further adding thereto 3 wt % of vinylene carbonate as an additive relative to the whole mixture.

(iv) Formation of Porous Film

A porous film paint was prepared by stirring, with a double arm kneader, 960 g of an inorganic oxide filler, 500 g of “BM-720H (trade name)” manufactured by ZEON Corporation as a film binder and a proper amount of NMP. It should be noted that BM-720H manufactured by ZEON Corporation is an NMP solution containing 8 wt % of a modified acrylonitrile rubber (film binder). Alumina (AES-12 manufactured by Sumitomo Chemical Co., Ltd.) having an average particle diameter on a volume basis (median diameter) of 0.5 μm and a BET specific surface area of 7 m²/g was used as the inorganic oxide filler. The obtained porous film paint was applied onto both sides of the negative electrode hoop, followed by drying to form a porous film having a thickness of 6 μm on each side.

(e) Assembly of Battery

A cylindrical lithium ion secondary battery as shown in FIG. 1 was fabricated.

The positive electrode hoop and the negative electrode hoop, which was provided with the porous film, were wound with a separator comprising a 20 μm-thick polyethylene microporous film disposed therebetween, thus forming an electrode plate group. The obtained electrode plate group was inserted into the battery case. Then, 5.5 g of the non-aqueous electrolyte was injected into the battery case, and the opening of the case was sealed. Thus, a cylindrical battery with a diameter of 18 mm, a height of 65 mm and a design capacity of 2000 mAh was completed.

### Example 2

An aqueous solution containing cobalt sulfate at a concentration of 0.90 mol/L, magnesium nitrate at a concentration of 0.05 mol/L and aluminum nitrate at a concentration of 0.05 mol/L was prepared. Using this aqueous solution, a hydroxide, namely Cu_{0.90}Mg_{0.05}Al_{0.05}(OH)₂, serving as the precursor of the active material was synthesized according to Example 1. This precursor was placed in a baking furnace, and preliminarily baked at 500° C. for 12 hours in the air atmosphere, thereby obtaining a predetermined oxide.

A lithium composite oxide (positive electrode active material) represented by Li (Co_{0.90}Mg_{0.05}Al_{0.05})O₂ was obtained by performing the same operation as in Example 1, except that the oxide obtained by the preliminary baking and lithium carbonate were mixed such that the molar ratio of lithium, cobalt, magnesium and aluminum was 1:0.90:0.05:0.05. Then, a cylindrical battery was fabricated in the same manner as in Example 1, except that this positive electrode active material was used.

### Comparative Example 1

A cylindrical battery was fabricated in the same manner as in Example 1, except that LiCoO₂, which does not contain magnesium, was used as the positive electrode active material.

### Comparative Example 2

A cylindrical battery was fabricated in the same manner as in Example 1, except that a negative electrode in which the porous film was not formed on the negative electrode material mixture layer was used.

### Example 3

A cylindrical battery was fabricated in the same manner as in Example 1, except that the porous film was formed on the positive electrode material mixture layer, instead of on the negative electrode material mixture layer.

Evaluation

The battery capacities of the fabricated batteries were measured in the following manner. In addition, a nail penetration test and a 180-degree peel test were performed in the following manner. The results are shown in Table 1.

Battery Capacities

First, each of the batteries was subjected to preliminary charging/discharging in the patterns shown below. Thereafter, each of the batteries was stored for seven days under an environment with 45° C.

1) constant current charge: 400 mA (end voltage 4.0 V)

2) constant current discharge: 400 mA (end voltage 3.0 V)

3) constant current charge: 400 mA (end voltage 4.0 V)

4) constant current discharge: 400 mA (end voltage 3.0 V)

5) constant current charge: 400 mA (end voltage 4.0 V)

Thereafter, charging/discharging was performed as follows.

6) constant current preliminary discharge: 400 mA (end voltage 3.0)

7) constant current charge: 1400 mA (end voltage 4.20 V)

8) constant voltage charge: 4.20 V (end current 100 mA)

9) constant current discharge: 400 mA (end voltage 3.0 V)

The discharge capacities were determined at the last discharge.

Nail Penetration Test

First, each of the batteries was subjected to preliminary charging/discharging in the patterns shown below. Thereafter, each of the batteries was stored for seven days under an environment with 45° C.

1) constant current charge: 400 mA (end voltage 4.0 V)

2) constant current discharge: 400 mA (end voltage 3.0 V)

3) constant current charge: 400 mA (end voltage 4.0 V)

4) constant current discharge: 400 mA (end voltage 3.0 V)

5) constant current charge: 400 mA (end voltage 4.0 V)

Thereafter, charging was performed as follows.

6) constant current preliminary discharge: 400 mA (end voltage 3.0)

7) constant current charge: 1400 mA (end voltage 4.25 V)

8) constant voltage charge: 4.25 V (end current 100 mA)

Five pieces each of these charged batteries were provided, and an iron wire nail having a diameter of 2.7 mm was penetrated into them from their side at a speed of 5 mm/sec under an environment with 20° C., and the heat generation state at that time was observed. The maximum temperature reached was measured by attaching a thermocouple to each battery at a portion of its surface that was 2 cm away from the point of nail penetration, and the average value of the five pieces of batteries was determined.

180-Degree Peel Test

The 180-degree peel test was carried out in compliance with JIS Z 0237. Specifically, an adhesive tape was attached to the surface of an electrode having a width of 15 mm as a test strip, then the adhesive tape was pulled away at an angle of 180 degrees with respect to the surface of the electrode, and the peel strength (g/f) when the electrode material mixture layer was peeled off from the current collector was measured.

TABLE 1

| | | | Temperature | |
|---|---|---|---|---|
| | | | reached | 180- |
| | | Battery | during nail | degree |
| | | capacity | penetration | peel test |
| | Composition | (mAh) | (° C.) | (g/f) |
| Example 1 | LiCo_{0.95}Mg_{0.05}O₂ | 2004 | 74 | 2 |
| Example 2 | LiCo_{0.90}Mg_{0.05}Al_{0.05}O₂ | 1992 | 53 | 5 |
| Example 3 | LiCo_{0.95}Mg_{0.05}O₂ | 2005 | 72 | 2 |
| Com. | LiCoO₂ | 2016 | 120 | 2 |
| Ex. 1 | | | | |
| Com. | LiCo_{0.95}Mg_{0.05}O₂ | 2007 | 135 | 2 |
| Ex. 2 | | | | |

### Example 4

Cylindrical batteries were fabricated in the same manner as in Example 1, except that the following oxides were used as the inorganic oxide filler in place of the alumina, and they were similarly evaluated. The results are shown in Table 2.

<a> magnesia having an average particle diameter on a volume basis (median diameter) of 0.5 μm

<b> silica having an average particle diameter on a volume basis (median diameter) of 0.5 μm

<c> zirconia having an average particle diameter on a volume basis (median diameter) of 0.5 μm

<d> titania having an average particle diameter on a volume basis (median diameter) of 0.5 μm

TABLE 2

| | | | Temperature | |
|---|---|---|---|---|
| | | | reached | |
| | | Battery | during nail | 180-degree |
| | Inorganic | capacity | penetration | peel test |
| | oxide filler | (mAh) | (° C.) | (g/f) |
| Example 1 | alumina | 2004 | 74 | 2 |
| Example 4 | magnesia | 2005 | 72 | 2 |
| | silica | 2003 | 73 | 2 |
| | zirconia | 2004 | 74 | 2 |
| | titania | 2004 | 73 | 2 |

### Example 5

Lithium composite oxides (positive electrode active materials) having the compositions listed in Table 1 were obtained by performing the same operation as in Example 1, except that strontium nitrate, yttrium nitrate, zirconium nitrate, calcium nitrate or titanium nitrate was used in place of magnesium nitrate when preparing the hydroxide serving as the precursor of the positive electrode active material. Then, cylindrical batteries were fabricated in the same manner as in Example 1, except that these positive electrode active materials were used, and they were similarly evaluated. The results are shown in Table 3.

TABLE 3

| | | | Temperature | |
|---|---|---|---|---|
| | | | reached | |
| | | Battery | during nail | 180-degree |
| | | capacity | penetration | peel test |
| | Composition | (mAh) | (° C.) | (g/f) |
| Example 5 | LiCo_{0.95}Mg_{0.05}O₂ | 2004 | 74 | 2 |
| | LiCo_{0.95}Sr_{0.05}O₂ | 2001 | 76 | 2 |
| | LiCo_{0.95}Y_{0.05}O₂ | 2002 | 78 | 2 |
| | LiCo_{0.95}Zr_{0.05}O₂ | 2001 | 75 | 2 |
| | LiCo_{0.95}Ca_{0.05}O₂ | 2000 | 77 | 2 |
| | LiCo_{0.95}Ti_{0.05}O₂ | 2001 | 76 | 2 |

### Example 6

Lithium composite oxides (positive electrode active materials) having the compositions listed in Table 4 were obtained by performing the same operation as in Example 1, except that the concentration ratio of cobalt sulfate and magnesium nitrate in the aqueous solution was varied when preparing the hydroxide serving as the precursor of the positive electrode active material. Then, cylindrical batteries were fabricated in the same manner as in Example 1, except that these positive electrode active materials were used, and they were similarly evaluated. The results are shown in Table 4.

### Comparative Example 3

Cylindrical batteries were fabricated in the same manner as in Example 6, except that a negative electrode in which the porous film was not formed on the negative electrode material mixture layer was used, and they were similarly evaluated. The results are shown in Table 4.

TABLE 4

| | | | Temperature | |
|---|---|---|---|---|
| | | | reached | |
| | | Battery | during nail | 180-degree |
| | | capacity | penetration | peel test |
| | Composition | (mAh) | (° C.) | (g/f) |
| Com. Ex. 1 | LiCoO₂ | 2016 | 120 | 2 |
| Com. Ex. | LiCo_{0.997}Mg_{0.003}O₂ | 2013 | 115 | 2 |
| Example 6 | LiCo_{0.995}Mg_{0.005}O₂ | 2011 | 78 | 2 |
| | LiCo_{0.99}Mg_{0.01}O₂ | 2009 | 76 | 2 |
| Example 1 | LiCo_{0.95}Mg_{0.05}O₂ | 2004 | 74 | 2 |
| Example 6 | LiCo_{0.9}Mg_{0.1}O₂ | 2004 | 71 | 2 |
| | LiCo_{0.85}Mg_{0.15}O₂ | 1985 | 70 | 2 |
| Com. Ex. | LiCo_{0.83}Mg_{0.17}O₂ | 1900 | 68 | 2 |
| Com. Ex. | LiCo_{0.8}Mg_{0.2}O₂ | 1738 | 67 | 2 |
| Com. Ex. 3 | LiCoO₂ | 2018 | 120 | 2 |
| | LiCo_{0.997}Mg_{0.003}O₂ | 2016 | 122 | 2 |
| | LiCo_{0.995}Mg_{0.005}O₂ | 2013 | 125 | 2 |
| | LiCo_{0.99}Mg_{0.01}O₂ | 2012 | 130 | 2 |
| | LiCo_{0.95}Mg_{0.05}O₂ | 2007 | 135 | 2 |
| | LiCo_{0.9}Mg_{0.1}O₂ | 2006 | 133 | 2 |
| | LiCo_{0.85}Mg_{0.15}O₂ | 1987 | 134 | 2 |
| | LiCo_{0.83}Mg_{0.17}O₂ | 1892 | 136 | 2 |
| | LiCo_{0.8}Mg_{0.2}O₂ | 1747 | 135 | 2 |

### Example 7

Lithium composite oxides (positive electrode active materials) having the compositions listed in Table 5 were obtained by performing the same operation as in Example 2, except that gallium nitrate, indium nitrate or tantalum nitrate was used in place of aluminum nitrate when preparing the hydroxide serving as the precursor of the positive electrode active material. Then, cylindrical batteries were fabricated in the same manner as in Example 1, except that these positive electrode active materials were used, and they were similarly evaluated. The results are shown in Table 5.

TABLE 5

| | | | Temperature | |
|---|---|---|---|---|
| | | | reached | 180- |
| | | Battery | during nail | degree |
| | | capacity | penetration | peel test |
| | Composition | (mAh) | (° C.) | (g/f) |
| Example 2 | LiCo_{0.90}Mg_{0.05}Al_{0.05}O₂ | 1992 | 53 | 5 |
| Example 7 | LiCo_{0.90}Mg_{0.05}Ga_{0.05}O₂ | 1990 | 57 | 4 |
| | LiCo_{0.90}Mg_{0.05}In_{0.05}O₂ | 1989 | 59 | 4 |
| | LiCo_{0.90}Mg_{0.05}Tl_{0.05}O₂ | 1991 | 60 | 4 |

### Example 8

Lithium composite oxides (positive electrode active materials) having the compositions listed in Table 6 were obtained by performing the same operation as in Example 2, except that the concentration ratio of cobalt sulfate and aluminum nitrate in the aqueous solution was varied, while fixing the concentration of magnesium nitrate, when preparing the hydroxide serving as the precursor of the positive electrode active material. Then, cylindrical batteries were fabricated in the same manner as in Example 1, except that these positive electrode active materials were used, and they were similarly evaluated. The results are shown in Table 6.

### Comparative Example 4

Cylindrical batteries were fabricated in the same manner as in Example 8, except that a negative electrode in which the porous film was not formed on the negative electrode material mixture layer was used, and they were similarly evaluated. The results are shown in Table 6.

TABLE 6

| | | | Temperature | 180- |
|---|---|---|---|---|
| | | | reached | degree |
| | | Battery | during nail | peel |
| | | capacity | penetration | test |
| | Composition | (mAh) | (° C.) | (g/f) |
| Example 1 | LiCo_{0.95}Mg_{0.05}O₂ | 2004 | 74 | 2 |
| Example 8 | LiCo_{0.94}Mg_{0.05}Al_{0.01}O₂ | 2004 | 60 | 4 |
| Example 2 | LiCo_{0.90}Mg_{0.05}Al_{0.05}O₂ | 1992 | 53 | 5 |
| Com. Ex. | LiCo_{0.88}Mg_{0.05}Al_{0.07}O₂ | 1925 | 50 | 5 |
| Com. Ex. 2 | LiCo_{0.95}Mg_{0.05}O₂ | 2007 | 135 | 4 |
| Com. Ex. 4 | LiCo_{0.94}Mg_{0.05}Al_{0.01}O₂ | 2000 | 127 | 4 |
| | LiCo_{0.90}Mg_{0.05}Al_{0.05}O₂ | 1883 | 127 | 5 |
| | LiCo_{0.88}Mg_{0.05}Al_{0.07}O₂ | 1750 | 126 | 5 |

### Example 9

Lithium composite oxides (positive electrode active materials) having the compositions listed in Table 7 were obtained by performing the same operation as in Example 8, except that indium nitrate was used in place of aluminum nitrate and the concentration ratio of cobalt sulfate and indium nitrate in the aqueous solution was varied when preparing the hydroxide serving as the precursor of the positive electrode active material. Then, cylindrical batteries were fabricated in the same manner as in Example 1, except that these positive electrode active materials were used, and they were similarly evaluated. The results are shown in Table 7.

### Comparative Example 5

Cylindrical batteries were fabricated in the same manner as in Example 9, except that a negative electrode in which the porous film was not formed on the negative electrode material mixture layer was used, and they were similarly evaluated. The results are shown in Table 7.

TABLE 7

| | | | Temperature | 180- |
|---|---|---|---|---|
| | | | reached | degree |
| | | Battery | during nail | peel |
| | | capacity | penetration | test |
| | Composition | (mAh) | (° C.) | (g/f) |
| Example 1 | LiCo_{0.95}Mg_{0.05}O₂ | 2004 | 74 | 2 |
| Example 9 | LiCo_{0.94}Mg_{0.05}In_{0.01}O₂ | 2005 | 54 | 4 |
| | LiCo_{0.90}Mg_{0.05}In_{0.05}O₂ | 1991 | 50 | 4 |
| Com. Ex. | LiCo_{0.88}Mg_{0.05}In_{0.07}O₂ | 1932 | 47 | 5 |
| Com. Ex. 2 | LiCo_{0.95}Mg_{0.05}O₂ | 2007 | 135 | 4 |
| Com. Ex. 5 | LiCo_{0.94}Mg_{0.05}In_{0.01}O₂ | 2005 | 130 | 4 |
| | LiCo_{0.90}Mg_{0.05}In_{0.05}O₂ | 1991 | 127 | 4 |
| | LiCo_{0.88}Mg_{0.05}In_{0.07}O₂ | 1910 | 127 | 5 |

### Example 10

Cylindrical batteries were fabricated in the same manner as in Example 1, except that the following resins were used as the film binder in place of BM-720H manufactured by ZEON Corporation, and they were similarly evaluated. The results are shown in Table 8.

<a> PVDF (polyvinylidene fluoride)

<b> FEP (tetrafluoroethylene-hexafluoropropylene copolymer)

TABLE 8

| | | | Temperature | |
|---|---|---|---|---|
| | | | reached | |
| | | Battery | during nail | 180-degree |
| | | capacity | penetration | peel test |
| | Film binder | (mAh) | (° C.) | (g/f) |
| Example 1 | BM-720H | 2004 | 74 | 2 |
| Example 10 | PVDF | 2004 | 78 | 2 |
| | FEP | 2004 | 79 | 2 |

### Example 11

Cylindrical batteries were fabricated in the same manner as in Example 1, except that the weight ratio of the inorganic oxide filler and the modified acrylonitrile rubber (film binder) component included in 500 g of BM-720H manufactured by ZEON Corporation was varied as shown in Table 9, and they were similarly evaluated. The results are shown in Table 9.

TABLE 9

| | | | | Temperature | |
|---|---|---|---|---|---|
| | | | | reached | |
| | Film | | Battery | during nail | 180-degree |
| | binder | Filler | capacity | penetration | peel test |
| | (wt %) | (wt %) | (mAh) | (° C.) | (g/f) |
| Example | 1 | 99 | 2005 | 78 | 2 |
| 11 | 3 | 97 | 2005 | 76 | 2 |
| | 5 | 95 | 2004 | 74 | 2 |
| | 10 | 90 | 2002 | 69 | 2 |
| | 25 | 75 | 1999 | 65 | 2 |
| | 50 | 50 | 1995 | 61 | 2 |

### Example 12

Cylindrical batteries were fabricated in the same manner as in Example 1, except that the thickness of the porous film formed on the negative electrode material mixture layer was varied as shown in Table 10, and they were similarly evaluated. The results are shown Table 10.

TABLE 10

| | | | Temperature | |
|---|---|---|---|---|
| | Thickness | | reached | |
| | of porous | Battery | during nail | 180-degree |
| | film | capacity | penetration | peel test |
| | (μm) | (mAh) | (° C.) | (g/f) |
| Example | 0.5 | 2005 | 78 | 2 |
| 12 | 1 | 2005 | 77 | 2 |
| | 3 | 2004 | 75 | 2 |
| | 10 | 2002 | 70 | 2 |
| | 15 | 2000 | 68 | 2 |
| | 20 | 1997 | 65 | 2 |

### Example 13

“Alumina AA03 (trade name)” (primary particles of α-alumina having an average particle diameter on a volume basis (median diameter) of 0.3 μm) manufactured by Sumitomo Chemical Co., Ltd. was heated for one hour at 900° C. to connect the primary particles by diffusion bonding, thereby obtaining polycrystalline particles. The average particle diameter on a volume basis (median diameter) of the obtained polycrystalline particles was 2.6 μm. Cylindrical batteries were fabricated in the same manner as in Example 1, except that the thus obtained polycrystalline particles were used as the inorganic oxide filler, and they were similarly evaluated. The results are shown Table 11.

TABLE 11

| | | | Temperature | |
|---|---|---|---|---|
| | | | reached | |
| | | Battery | during nail | 180-degree |
| | Inorganic oxide | capacity | penetration | peel test |
| | filler | (mAh) | (° C.) | (g/f) |
| Example 13 | polycrystalline | 2004 | 75 | 2 |
| | particles | | | |

Consideration

As is clear from Table 1, the maximum temperature reached in the nail penetration test was significantly lower in Examples 1 to 3 than in Comparative Examples 1 and 2. Furthermore, a favorable result was obtained in each of the cases where the lithium composite oxide including a certain amount of the element M¹ such as Mg was used as the positive electrode active material and the porous film was formed on the negative electrode or on the positive electrode.

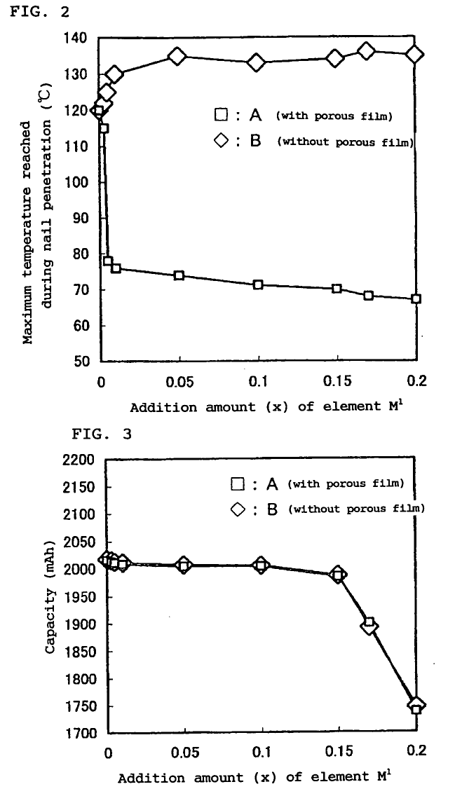

The results of the nail penetration test shown in Table 4 are shown together in FIG. 2. FIG. 2 shows a relationship between the addition amount (x) of the element M¹ (Mg) included in the lithium composite oxide and the maximum temperature reached during nail penetration. Further, FIG. 3 shows a relationship between the addition amount (x) of the element M¹ included in the lithium composite oxide and the battery capacity. Plot A (white squares) shows the relationship for the batteries including the porous film, and plot B (white diamonds) shows the relationship for the batteries including no porous film.

From FIG. 2, it can be seen that the batteries including no porous film exhibited a tendency in which, with an increase in the conductivity resulting from an increase in the thermal stability of the lithium composite oxide due to an increase in the amount of the element M¹ (Mg), the maximum temperature reached during nail penetration increased and thus the safety was reduced. On the other hand, it can be seen that the batteries including the porous film exhibited the exact opposite tendency. That is, they exhibited a tendency in which, with an increase in the conductivity of the lithium composite oxide due to an increase in the amount of the element M¹ (Mg), the maximum temperature reached during nail penetration dropped and thus the safety was improved. Furthermore, it can be seen that the safety was reduced when the amount of the element M¹ (Mg) was too small (x<0.005), regardless of the presence or absence of the porous film. However, from FIG. 3, it can be seen that the battery capacity rapidly decreased when 0.15<x.

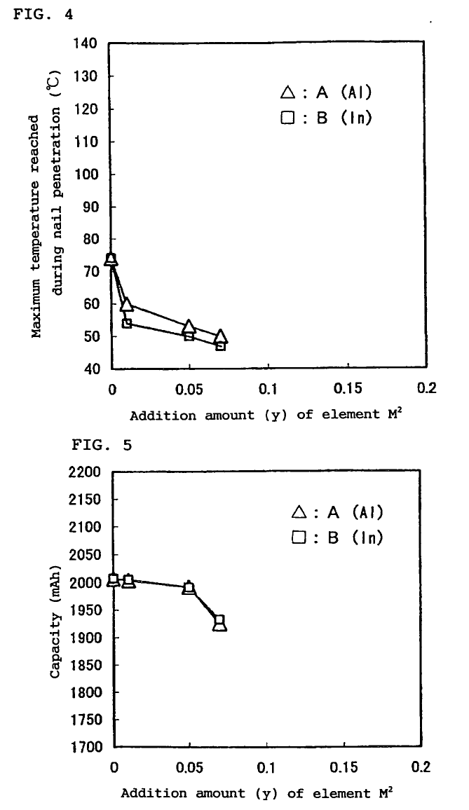

Of the results of the nail penetration test shown in Tables 6 and 7, the results for the batteries including the porous film are shown together in FIG. 4. FIG. 4 shows a relationship between the addition amount (y) of the element M² (Al, In) included in the lithium composite oxide and the maximum temperature reached during nail penetration. Further, FIG. 5 shows a relationship between the addition amount (y) of the element M² included in the lithium composite oxide and the battery capacity. Plot A (white triangles) shows the relationship for the batteries in which the element M² was Al, and plot B (white squares) shows the relationship for the batteries in which the element M² was In.

From FIG. 4, it can be seen that adding the element M² (Al, In) improved the safety of the battery in the nail penetration test even further and that this effect increased with an increase in the addition amount (y) of the element M². However, from FIG. 5, it can be seen that the battery capacity rapidly decreased when 0.05<y.

Although in the above-described examples, cases were described where the porous film was formed on the negative electrode or the positive electrode, a similar effect can also be achieved by forming the porous film on both of the electrodes.

### INDUSTRIAL APPLICABILITY

The present invention is useful in providing a lithium ion secondary battery with a very high level of safety that can suppress thermal runaway even in a nail penetration test and a heating test at a high temperature. Since the lithium ion secondary battery according to the present invention has a high level of safety, it can be applied in all fields, and particularly useful as power sources for driving electronic devices such as a notebook computer, a mobile phone and a digital still camera.

1. A lithium ion secondary battery comprising:
a positive electrode including a lithium composite oxide;
a negative electrode including a material capable of electrochemically absorbing and desorbing lithium;
a separator interposed between said positive electrode and said negative electrode;
a non-aqueous electrolyte; and
a porous film bonded to at least one selected from a surface of said positive electrode, a surface of said negative electrode and a surface of said separator,
wherein said porous film includes an inorganic oxide filler and a film binder, and
said lithium composite oxide is represented by the formula: Liₐ(Co_{1-x-y}Mₓ¹M_{y}²)_{b}O₂,
where element M¹ is at least one selected from the group consisting of Mg, Sr, Y, Zr, Ca and Ti, and element M² is at least one selected from the group consisting of Al, Ga, In and Tl, and
said formula satisfies 0<a≦1.05, 0.005≦x≦0.15, 0≦y≦0.05 and 0.85≦b≦1.1.

2. The lithium ion secondary battery in accordance with claim 1,
wherein said inorganic oxide filler includes at least one selected from the group consisting of alumina and magnesia, and a content of said inorganic oxide filler in the total of said inorganic oxide filler and said film binder is not less than 50 wt % and not more than 99 wt %.

3. The lithium ion secondary battery in accordance with claim 1,
wherein said film binder includes a rubbery polymer including an acrylonitrile unit.

4. The lithium ion secondary battery in accordance with claim 1,
wherein said positive electrode and said negative electrode are wound with said separator interposed therebetween.
